(19) United States
(12) Patent Application Publication
(10) Pub. No.: US 2007/0271162 A1
(43) Pub. Date: Nov. 22, 2007

(54) Invoice Management For Distributed Content

(76) Inventor: Gary Stephen Shuster, Fresno, CA (US)

Correspondence Address: CONNOLLY BOVE LODGE & HUTZ LLP, P.O. BOX 2207, WILMINGTON, DE, 19899, US

(21) Appl. No.: 11/557,083

(22) Filed: Nov. 6, 2006

Related U.S. Application Data
(60) Provisional application No. 60/734,515, filed on Nov. 7, 2005.

(51) Int. Cl. H04M 15/00

(52) U.S. Cl. 705/34

(57) ABSTRACT

Executable software may be provided to a computer. The software may be configured to perform a designated user-requested function on the computer. In addition, the software may be configured to perform a search of a memory of the user computer, looking for prospective billing addresses. The billing addresses may comprise street addresses or electronic mail addresses. The billing address information may be provided to a remote resource, optionally along with use information regarding the software. The provided information may be used to generate an invoice for use of the account that is provided to the billing address. The executable software may be provided under a license that provides for a free trial period and/or authorizes search and use of the billing information.

### CROSS-REFERENCE TO RELATED APPLICATION

This application claims priority pursuant to 35 U.S.C. § 119(e) to U.S. provisional application Ser. No. 60/734,515, filed Nov. 7, 2005, which application is specifically incorporated herein, in its entirety, by reference.

### BACKGROUND

1. Field of the Inventions

Embodiments of the present invention relate to managing invoicing for use of computer-distributed content.

2. Description of Related Art

Software for performing a designated user-requested function is sometimes provided for use on computers under a license that permits a period of free trial use, after which a license fee is due. Licenses of this type may sometimes be referred to as “shareware” licenses, with the underlying software referred to as “shareware.” Persons using shareware under such licenses may neglect to pay the license fee or intentionally avoid paying it, while continuing to use the software. In other cases, illegal copies of software or other digital content are made and distributed without collection of license fees to the copyright holder. Shareware is sometimes configured to cease to function if a license fee is not obtained after expiration of the trial period, but a determined user may sometimes continue to use it by installing a new trial version of the shareware, or by installing competing shareware configured to perform the same designated user-requested function. In other cases, illegal copies of software or other digital content may be made and distributed without collection of license fees to the copyright holder. In all of the foregoing scenarios, licensing fees may not be received for the use of software or other digital content, even though licensing fees may be due.

It would be desirable, therefore, to provide executable content so as to increase the likelihood of collecting fees due for use of the content.

### SUMMARY

A method and executable content are provided to improve software licensing revenues. The instant invention solves the problem of non-payment for distributors of shareware or other software by facilitating direct invoicing of users. The software may also be used to facilitate access to payment accounts.

In an embodiment of the invention, a distributed executable program or other content operates to obtain and convey billing information to a remote resource for generating an invoice. The remote resource may be configured to generate an invoice for sending to an operator of the computer system. In an alternative embodiment, a payment account belonging to operator of the computer system on which the executable content is being utilized, such as a credit line or debit account, may be directly charged for the license fee.

An operator of the computer system may load onto a licensee's computer a product, such as a software program capable of execution on the licensee's computer, and execute such product on the computer. The executable content may then initiate a search of the operator's computer system, including, if desired, a user's network. For example, the search of the computer system may include a search of resources on a local area network belonging to the user. Next, the executable product may process the search results to identify possible billing addresses associated with the operator of the computer system. In the alternative, the search results may be provided to a remote resource for processing.

The executable product may be configured to send at least a portion of the search results to a designated remote resource for generation of an invoice. The invoicing system identifies at least one likely billing address or account based on the search results returned by the executable program installed on the user computer.

In an embodiment of the invention, the user installing the executable content may consent to be invoiced or charged in the manner described above before the executable content is installed on the client computer. In this embodiment, if the user does not consent, the executable program may not be installed, or may be installed in a downgraded or partially disabled configuration. For example, the executable program may cease to operate after a defined period. In addition, the user may be required to represent that they have the legal right to install software onto the computer system that they are operating:

In an embodiment of the invention, the search of the licensee's computer system may take place after the expiration of a trial period. In the alternative, the search of the licensee's computer system may take place prior to the expiration of a trial period.

In an embodiment of the invention, an intellectual property owner may bill the licensee prior to the expiration of a trial period. In the alternative, the intellectual property owner may bill the licensee subsequent to the expiration of a trial period.

The billing address associated with the operator of the computer system may comprise a street address, such as a postal service mailing address. In the alternative, or in addition, the contact address associated with the operator of the computer system may comprise a non-physical address, such as an e-mail address or a facsimile machine phone number.

The search information may be transmitted along with information relating to use of the intellectual property. For example, configuration detail regarding the installation or frequency of use of the executable program may be provided. The executable program may function to provide copyrighted content, such as video content, audio content, photographs, text, or other works of authorship to the end user. In such case, usage information regarding the copyrighted content may be transmitted for billing purposes, or as survey information.

The invoice may be adjusted to account for the details of the use of the executable content, such as frequency of use, time since installation, or features utilized. Invoices may be sent on a recurring basis, or as a one-time event. Likewise, the search and transmission of data to the invoicing system may recur at intervals, or may occur once or any desired number of times.

One or more functions of the executable program may be disabled during such time as it is unable to communicate with the designated invoicing computer system or other remote resource. To circumvent software or hardware limitations on the ability of executed products to communicate over a network, the executable product may be configured to utilize trusted or standard ports, such as the “POP-3” port, the “SMTP” port, or the web services port. In the alternative, or in addition, the executable product may use interapplication control procedures, such as Microsoft's OLE, to cause another application, such as an e-mail client, to send the search results to the remote resource designated by the executed content.

A more complete understanding of the method and system for managing invoicing for use of computer-distributed content will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a schematic diagram showing exemplary aspects of a system for managing invoicing for use of executable content, according to an embodiment of the invention.

FIG. 2 is a block diagram showing exemplary aspects of executable content such as may be encoded on a digital storage medium for use in a computer, according to an embodiment of the invention.

FIG. 3 is an exemplary screenshot showing aspects of a shareware license that may be used in connection with providing executable content, according to an embodiment of the invention.

FIG. 4 is a flow diagram showing exemplary steps of a method for managing invoicing for use of computer-distributed content, according to an embodiment of the invention.

### DETAILED DESCRIPTION OF VARIOUS EMBODIMENTS

Various exemplary embodiments of the invention are disclosed in the detailed description that follows. FIG. 1 is a schematic diagram showing aspects of a system 100 for managing invoicing for use of executable content, according to an embodiment of the invention. It should be appreciated that the system may be implemented on any suitable computing platform.

System 100 may comprise a first server 102 configured for communication with remote clients running instances of distributed executable content. It should be appreciated that server 102 may comprise any number of coordinated processors or servers, for example, a single machine, or a bank of connected machines. Computer 102 may be programmed using software or firmware as known in the art. Program instructions may be encoded within a digital storage medium 104, configured for causing the computer to perform a method as herein described. Storage medium 104 may comprise any suitable magnetic, optical, or electronic medium used for storing digital information for use in a computer.

Server 102 may be connected, such as via a wide area network 108, to a plurality of remote clients 110 (one of many shown). A plurality of remote clients may be connected via a local area network to a firewall or other server (not shown). Any suitable network topology may be used for connecting the server 102 to the client 110. Server 102 and/or client 110 may also be configured to communicate with one or more financial services servers 112, for example as operated by a bank or other financial institution for servicing debit or credit cards. Client 101 and server 102 may also be configured to communicate with one or more mail servers 114.

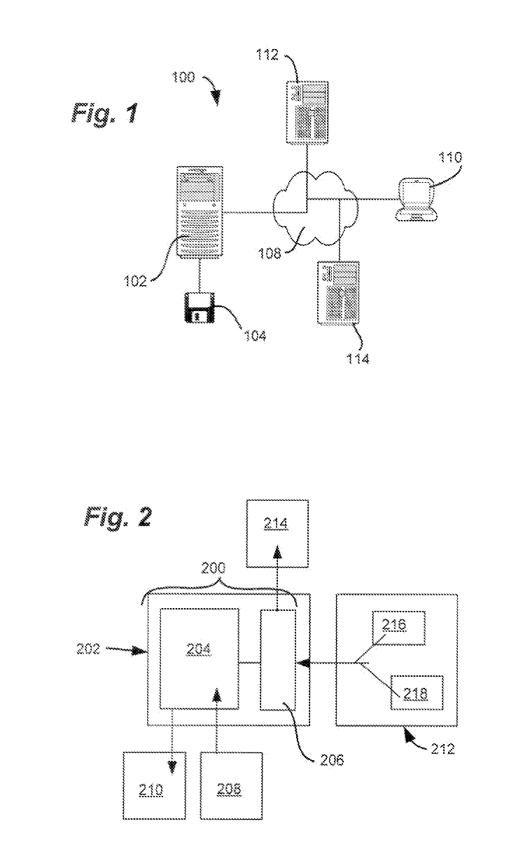

In an embodiment of the invention, a client computer receives executable code configured in a specific way, for example by downloading a “shareware” or other program from a network site, or loading the program from an optical or magnetic disk, or from an electronic memory device. FIG. 2 therefore shows exemplary aspects of executable content 200 such as may be encoded on a digital storage medium 202 for use in a computer, according to an embodiment of the invention. Digital storage medium 202 may be operably associated with a client computer, for example, as an internal hard drive or random access memory (RAM) unit. Alternatively, storage medium 202 may comprise a portable storage medium, or a storage medium at a server location from which the executable content 202 may be downloaded to multiple client computers.

Executable content 200 may comprise separate portions: a first portion 204 configured to provide designated user-requested content to a client computer, and a second portion 206 configured to search a memory of the client computer for a billing address. One of ordinary skill in the programming art may prepare executable content 202 comprising first and second functional portions 204, 206 using any suitable programming language and any number of programming lines, modules, or other objects. Optionally, the distinction between the first and second portions may be purely functional. These portions may be written using separate modules or other code objects, may share certain objects, or may co-exist within the same code objects.

First portion 204 may be configured to provide designated user-requested content to a client computer, for example, as an application performing any desired function. As such, portion 204 may be configured to receive input from a user input device 208, for example a keyboard, pointing device, touch screen, or microphone, and provide output for a user output device 210, for example, a display screen, printer, or audio system. The designated function performed by portion 204 may be any function desired by the user. Video clips or players, music clips or players, applications for various functions, e.g., word processing, signal processing, data processing, graphics generation, video editing, etc., are but a few examples of designated user-requested content.

Second portion 206 may be configured to search a memory of the client computer for a billing address, and to communicate search results to a billing server 214. As such, portion 206 may be configured to search a static memory 212 belonging to the client so as to locate probable billing addresses. Memory 212 may comprise, for example, a magnetic or optical storage disk for digital data, or an electronic storage unit such as comprising non-volatile memory chips. Various information may be searched to locate probable billing addresses. In an embodiment of the invention, portion 206 may operate to locate and parse electronic mail messages or mail configuration files 216 to identify one or more electronic mail addresses belonging to the client. Optionally, mail messages stored on the client may be analyzed to locate an active client address, or the most active email address stored on the computer. In addition, or in the alternative, portion 206 may be configured to search text documents or word processing documents 218 to identify correspondence with return addresses. One or more letters are found, for example, having a return address of “John Doe, 123 Main Street, Anywhereville, Calif.,” this may support a conclusion that a physical or street address of the user of the client computer is as stated. Other factors may also be used to determine whether a billing address is likely to be current and valid, for example, the number and date of letters having a particular return address. Other files may also be searched for address information, for example, system configuration files or Internet “cookie” files. Addresses may include phone numbers, and particular facsimile numbers.

Searches of client systems for billing addresses may be conducted in the background while portion 204 is operating, during system idle time, or at any other desired time. Searches may be initiated by any desired trigger, for example when executable content 200 is first installed on a client system, when it is first operated, after expiration of a free trial period, or at a particular data and time. Searches may also be performed periodically to obtain updated information, for example, monthly.

Portion 206 may be configured to report search results to a billing processing server 214. In an embodiment of the invention, the portion 206 may be configured to utilize trusted or standard ports, such as the “POP-3” port, the “SMTP” port, or the web services port. This may be useful, for example, to circumvent software or hardware limitations on the ability of executed content to communicate over a network to a billing server. In the alternative, or in addition, the portion 206 may use interapplication control procedures, such as Microsoft's OLE, to cause an e-mail client to send the search results to the billing server or other remote resource designated by the executable content. Raw search results may be reported, or in the alternative, a processed report indicating one or more probable billing addresses or phone numbers. Optionally, such reports may include an indication of the basis for selecting a billing address, for example, the information searched, the number of files containing the billing address, the date of such files, adjacent information in such files, or other information that may be used to assess the reliability of a selected billing address. Also optionally, a report provided to the billing server may comprise an assessment of the reliability of a billing address, for example a confidence score.

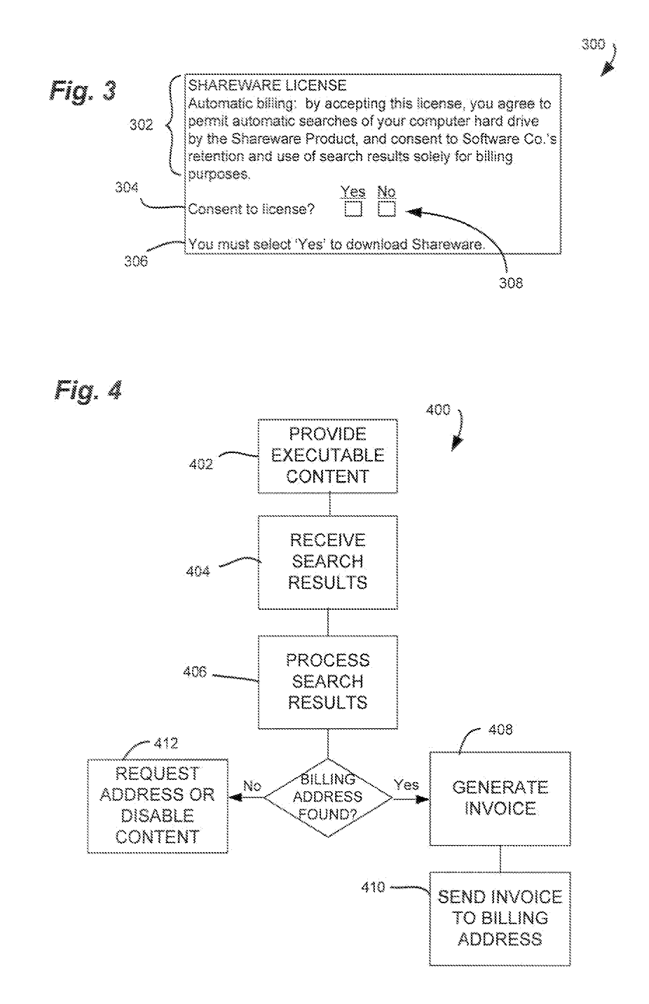

In an embodiment of the invention, executable content may be downloaded or installed on a client computer in association with a “click-through” license specifying the terms of use. FIG. 3 is an exemplary screenshot 300 showing aspects of a shareware license that may be used in connection with providing executable content. An installation or download screen 300 may include a license term 302 requiring the user's consent to automatic searches of the client memory for billing information, and to the software provider's retention and use of such information for billing purposes. Screen 300 may further include clickboxes 308 or other objects whereby a user may expressly accept or reject the license terms. The screen may also include a message 306 informing the user that use of the software is conditioned on acceptance of the license terms.

FIG. 4 shows exemplary steps of a method for managing invoicing for use of computer-distributed content, according to an embodiment of the invention. At step 402, executable content is provided, for example, as a file to be downloaded from a website, or as content encoded on a digital storage medium. The executable content may be configured as described above in connection with FIG. 2 and elsewhere in the specification. If downloaded as a shareware application, information such as shown in FIG. 3 may be provided at or around the time the application is downloaded from a Website. If provided on a storage medium, similar information may be displayed at or around the time that the stored content is installed on a client computer. After being installed on the client computer, the executable content may automatically perform a search of a memory of the client, looking for one or more billing addresses, as described in more detail above. In an embodiment of the invention, the executable content may also be configured to provide information regarding use of the executable content on the client, for example, the installation date, the duration and times of use, or functions used. The executable content may then communicate search results and optionally, use information, to a remote resource, such as a billing server.

Accordingly, at step 404, search results are received by a remote resource. Any suitable method of communication may be used to communicate and receive search results, including but not limited to FTP, electronic mail, SMS text messaging, Internet cookies, or any other suitable method. Optionally, search results may be encrypted before being sent, and decrypted at the receiving end, using any suitable method. Received search results may be stored in a secure computer memory for use in processing and billing.

At step 406, search results may be processed to identify a billing address. In addition, an invoice amount may be calculated based on use information. Processing may be performed by the executable content on the client computer, by software located on a remote resource such as a billing server, or at both client and server locations. A billing address may comprise a physical street address, an electronic address, or a phone number. In an embodiment of the invention, a billing address may comprise an address of a financial institution and an account number for a client account managed by the account, for example a VISA™ or Paypal™ account. An invoice amount may be calculated based on expiration of a free trial period for the executable content, a period of use, functions used, content viewed, or any other basis for assessing a license fee.

Candidate billing addresses may be reviewed by a human operator and/or processed an automatic expert system to confirm whether or not the address appears to be valid. To the extent reverse-lookup records are available, addresses may also be verified using reverse lookup to determine whether the resident or account name matches the client name. If one or more addresses appears to be valid, an invoice for an amount due may be generated at step 408. The invoice may be addressed and sent to the billing address, as indicated at step 410. If more than one billing address is identified, multiple invoices may be prepared and sent, one for each address.

Optionally, if no valid billing address is found, an address may be requested from the client, as indicated at step 412. In addition, or in the alternative, some portion or all of the executable content may be disabled if a billing address is not available, or if payment is not received within a defined period of time, for example, one to three months, after an invoice is sent. If payment is not received, a billing or payment server may communicate with the executable content on the non-paying client, which may then operate a routine configured to disable the executable content in any desired fashion.

Having thus described various embodiments of the system and method for managing invoicing for use of computer-distributed content, it should be apparent to those skilled in the art that certain advantages of the within system have been achieved. It should also be appreciated that various modifications, adaptations, and alternative embodiments thereof may be made within the scope and spirit of the present invention, which is not limited to the described embodiments.

What is claimed is:

1. A method for managing invoicing for use of computer-distributed content, the method comprising:
providing digital executable content for to a remote computer, the executable content configured to search a memory of the remote computer for a billing address;
receiving the billing address originating from the executable content on the remote computer;
generating an invoice for use of the executable content; and
addressing the invoice to the billing address.

2. The method of claim 1, further comprising providing the executable content configured to search for a billing account number, and including the billing account number on the invoice.

3. The method of claim 1, further comprising providing the executable content subject to a license agreement requiring consent to a search of the remote computer memory.

4. The method of claim 3, further comprising providing the license specifying a free trial period for use of the executable content, after expiration of which a license fee is due if the executable content is used.

5. The method of claim 3, further comprising providing the executable content configured to search the remote computer memory after expiration of the free trial period.

6. The method of claim 3, wherein the step of generating an invoice is performed after expiration of the free trial period.

7. The method of claim 1, further comprising providing the executable content configured to search the remote computer memory for a street address comprising at least a portion of the billing address.

8. The method of claim 1, further comprising providing the executable content configured to search the remote computer memory for an electronic mail address comprising at least a portion of the billing address.

9. The method of claim 1, further comprising providing the executable content configured to provide information regarding use of the executable content on the remote computer.

10. The method of claim 9, wherein the step of generating the invoice further comprises computing an invoice amount based on the information regarding use of the executable content.

11. The method of claim 9, further comprising providing the executable content configured to provide information regarding ongoing use of the executable content on the remote computer at periodic intervals.

12. The method of claim 11, further comprising generating additional invoices having invoice amounts based on the information regarding ongoing use.

13. The method of claim 1, further comprising providing the executable content configured to search resources on a local area network connected to the remote computer.

14. The method of claim 1, further comprising providing the executable content configured provide the billing address to a remote resource at a defined network address.

15. The method of claim 14, further comprising providing the executable content configured to disable at least one function of the executable content if the executable content is unable to communicate with the remote resource.

16. The method of claim 14, further comprising providing the executable content configured to provide the billing address to the remote resource using a trusted port of the remote computer, selected from the POP-3 port, the SMTP port, or the web services port.

17. The method of claim 14, further comprising providing the executable content configured to cause an electronic mail application on the remote computer to electronically mail the billing address to the remote resource.

18. A digital storage medium encoded with executable content configured to:
provide designated user-requested content on a computer;
to search a memory of the remote computer for a billing address;
provide the billing address to a remote resource at a defined network address.

19. The digital storage medium of claim 18, wherein the executable content is further configured to search the memory for a billing account number, and to include the billing account number on the invoice.

20. The digital storage medium of claim 18, wherein the executable content is further configured to search the memory for a billing account number, and to include the billing account number on the invoice.

21. The digital storage medium of claim 18, wherein the executable content is further configured to search the remote computer memory for a street address comprising at least a portion of the billing address.

22. The digital storage medium of claim 18, wherein the executable content is further configured to search the remote computer memory for an electronic mail address comprising at least a portion of the billing address.

23. The digital storage medium of claim 18, wherein the executable content is further configured to provide information regarding use of the designated user-requested content on the remote computer.

24. The digital storage medium of claim 23, wherein the executable content is further configured to provide information to the remote resource regarding ongoing use of the executable content on the remote computer at periodic intervals.

25. The digital storage medium of claim 18, wherein the executable content is further configured to search resources on a local area network connected to the remote computer.

26. The digital storage medium of claim 18, wherein the executable content is further configured to disable at least one function of the executable content if the executable content is unable to communicate with the remote resource.

27. The digital storage medium of claim 18, wherein the executable content is further configured to provide the billing address to the remote resource using a trusted port of the remote computer, selected from the POP-3 port, the SMTP port, or the web services port.

28. The digital storage medium of claim 18, wherein the executable content is further configured to cause an electronic mail application on the remote computer to electronically mail the billing address to the remote resource.
